(19) United States
(12) Patent Application Publication
(10) Pub. No.: US 2008/0060274 A1
(43) Pub. Date: Mar. 13, 2008

(54) In joinery

(76) Inventor: Darryl Vooght, Hamilton (NZ)

Correspondence Address: DICKSTEIN SHAPIRO LLP, 1825 EYE STREET NW, Washington, DC, 20006-5403, US

(21) Appl. No.: 11/890,508

(22) Filed: Aug. 7, 2007

(30) Foreign Application Priority Data
Aug. 7, 2006 (NZ) NZ 549032

(51) Int. Cl. E05B 65/06

(52) U.S. Cl. 49/394

(57) ABSTRACT

This invention relates to joinery and particularly to closures for openings. A bi-fold joinery configuration, which facilitates the convenient orientation of joinery panels toward alignment with adjacent portions of a wall aligned with the plane of the opening, is provided.

### FIELD OF THE INVENTION

This invention relates to joinery and particularly to closures for openings.

### BACKGROUND TO THE INVENTION

References made to “bi-fold” joinery, refers to joinery which typically has a frame engageable in a building wall said frame defining a head and an opposed sill linked by jambs. The joinery frame typically mounts closure panels, such as window sashes or doors at least in pairs (possibly in multiple pairs) with or without an additional “casement” leaf. In a closed position, the panels are engaged across the opening to close the opening. The pivotally interconnected panel pairs are connected pivotally to one adjacent frame jamb for such pairs with the panel adjacent the frame pivotally connected thereto to panels to concertina toward the frame jamb to open the opening.

In the past, bi-fold door assemblies have been common in joinery construction. Typically they have been used in building to provide a closure for an opening where, when opened, the opening has few or no obstructions, for example, mullions or fixed leaves and the like, common with casement doors, sliding doors and the like.

Almost all joinery presents a compromise. Bi-fold joinery configurations are no exception. While bi-fold joinery configurations provide a relatively unobstructed opening when in the open position, provision normally has to be made for accommodating at least a pair of panels, or in multiple bi-fold configurations a “stack” of panels, which typically project beyond the plane of the opening. This is generally not a problem where the opening is adjacent an orthogonally projecting wall, however, in instances where such openings project onto a deck, pathway and the like, projecting concertinaed bi-fold panels can represent not only a nuisance, but also a significant danger.

Various attempts have been made to arrange bi-fold joinery configurations in a manner whereby the bi-folded panels can, when they approach an open position, be rotated from the substantially orthogonally projecting position, toward a position whereby they substantially align with the opening, typically overlying either portions of the exterior or interior wall adjacent to the opening.

Typical examples include the well known Henderson™ Door gear which includes top track hung doors arranged to concertina toward the opening side; the track being arranged with arcuate end portions out of register with remaining portions of the opening head, such that the concertinaed stack of doors can be pivoted internally of the opening to substantially align with a wall adjacent to the opening in the plane of the opening.

Other arrangements have included the provision of supporting tracks which are out of alignment with the opening to position support for panels of the concertinaed closure out of alignment with the opening to thus create geometry enabling the concertinaed panels to be moved when open toward alignment with portions of the interior or exterior of the wall in the plane of the opening.

Such prior art arrangements require complications such as unsightly projecting track portions. Out of alignment tracks leads to complication in manufacture and thus expense, further they tend to, in use, create a susceptibility for ongoing maintenance, need for required adjustment and the like.

Leverage created by the weight of closure panels on an associated frame and any interlinking equipment in prior art arrangements can be significant, leading to frame distortion, sagging, twisting and the like. This requires additional or remedial support and thus leading to cost and complication in installation. Jamming effects of the distortion on bi-fold panels and significant load on the support and related structures is a particular problem with panels of larger sizes.

Whilst the invention is described with reference to predominantly metal joinery, typically joinery formed predominantly in extruded aluminium alloy, it is to be understood that this invention is not limited to this form of joinery construction idiom.

Relative and directional references in this specification are those typical for the joinery, when it is in use.

### OBJECT OF THE INVENTION

It is an object of this invention to provide a bi-fold joinery configuration which facilitates the convenient rotating of joinery panels toward alignment with adjacent portions of a wall aligned with the plane of the opening.

It is a further object of this invention to come some way to addressing the problems of the prior art, or at least to provide the public with a useful choice.

Other objects of this invention will become apparent from the following description which is given by way of example with reference to, one embodiment of the invention.

### SUMMARY OF THE INVENTION

According to one aspect of this invention there is provided a closure for an opening including at least one pair of panels, wherein a first side of a first panel of the pair of panels is pivotally mounted adjacent a side of a frame to pivot from a position wherein the panel is substantially in alignment with the opening, through a position substantially orthogonal to the opening and beyond, the first side of a second panel is pivotally mounted adjacent a second side of the first panel, the second side of the first panel being substantially opposite the first side of the first panel, and a portion adjacent the second side of the second panel is engaged with portions of the opening, the panels being moveable from a closed position across the opening to a position where the panels are substantially concertinaed together, the second side of the second panel including a primary portion moveably engaged with the opening and a secondary portion pivotally connected to the primary portion, the secondary portion being capable of movement from substantial alignment with the primary portion to substantial alignment with remaining portions of the second panel as said concertinaed panels are moved toward alignment with the opening but remote from the opening.

Preferably, the primary and secondary portions are pivotally connected via hinges engaged therebetween.

Preferably a releasable securing means is positioned adjacent to the primary and secondary portions to releasably retain the primary and secondary portions in alignment, and to facilitate release of said alignment when predetermined.

Preferably the securing means is magnetic.

Preferably the closure includes a releasable latch that automatically latches upon alignment of the primary and secondary portions.

Preferably the latch includes a hook and a catch.

Preferably the engagement between the second side of said second panel and said frame is arranged to align within the periphery of the frame.

Preferably at least one portion of the engagement is positioned to support the panels relative to the frame.

Other aspects of this invention which should be considered in all its novel aspects will become apparent from the following description.

Modifications, developments and material substitution are envisaged and may be incorporated without departing from the scope or spirit of the invention as described in this specification.

### FIGURES

Turning now to the embodiment described, reference is made to the accompanying drawings in which:

FIG. 1: is a partial schematic cutaway perspective view of a portion of a bi-fold door assembly including a portion of frame engaged in a wall opening and a pair of bi-fold closure panels, in this case doors have been concertinaed toward a traditional open position whereby said panels project outwardly of the opening relative to the opening plane.

FIG. 2: is a view similar to that of FIG. 1, however, the doors have been rotated to approximate alignment with the plane of the opening, aligning such that they are substantially parallel with portions of the wall adjacent to the frame opening.

FIG. 3: shows a perspective view of a preferred embodiment of the invention.

Whilst the invention is described with reference to external opening of closure panels, as is typical construction idiom in New Zealand, it is to be appreciated that the construction and arrangement of the joinery configuration is also able to meet typical construction idiom in Europe and some parts of Northern America, where such joinery opens inwards, typically in areas of heavy snow fall or where buildings project immediately onto access ways, footpaths, service lanes and the like by substantially reversing the exterior/interior aspect of the joinery and appropriate sealing on the like.

While the invention is described with reference to joinery construction in extruded aluminium alloy, it is to be appreciated that the invention is not limited to this form of construction. The invention could alternatively be applied to other forms of joinery including those in timber, plastics, other metal and the like, either fully or in combination with other elements.

Whilst the invention is described with reference to door closure configuration, and with reference to “bi-fold hinging” (i.e. side or casement style hinging), the invention is not so limited. The construction and arrangement of the invention is also envisaged as applicable to window configurations and to configurations where the concertina hinging of said panels is arranged other than upright as described in the present form, including the substantially horizontal plane.

A horizontal plane hinging configuration is envisaged as particularly suited to commercial application or for closures for vehicle access and the like.

Whilst the form of the invention described is arranged for substantially hand operation, it is envisaged that powered opening, and closing of the apparatus of this invention is able to be incorporated without departing from the invention.

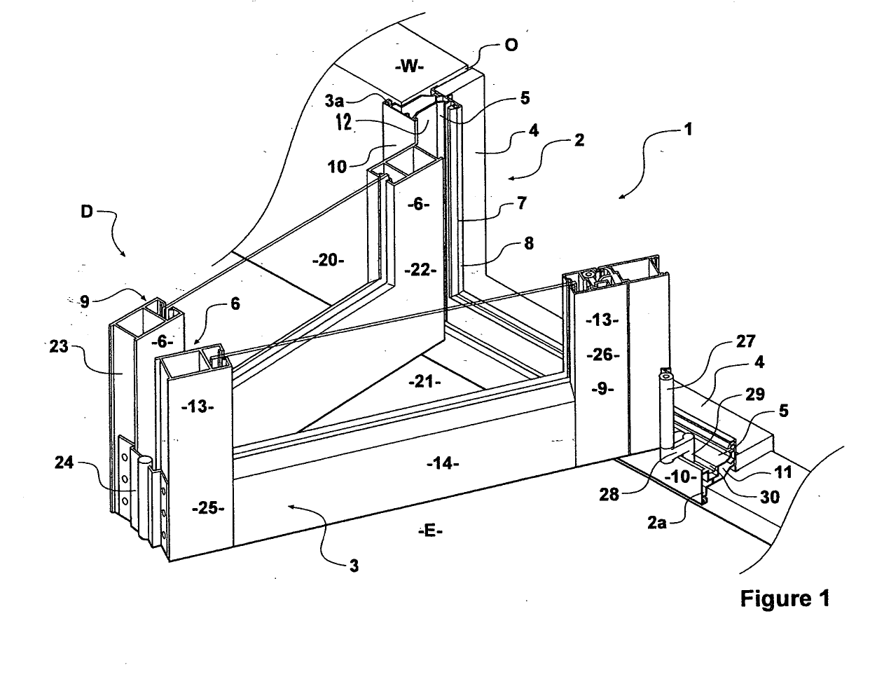

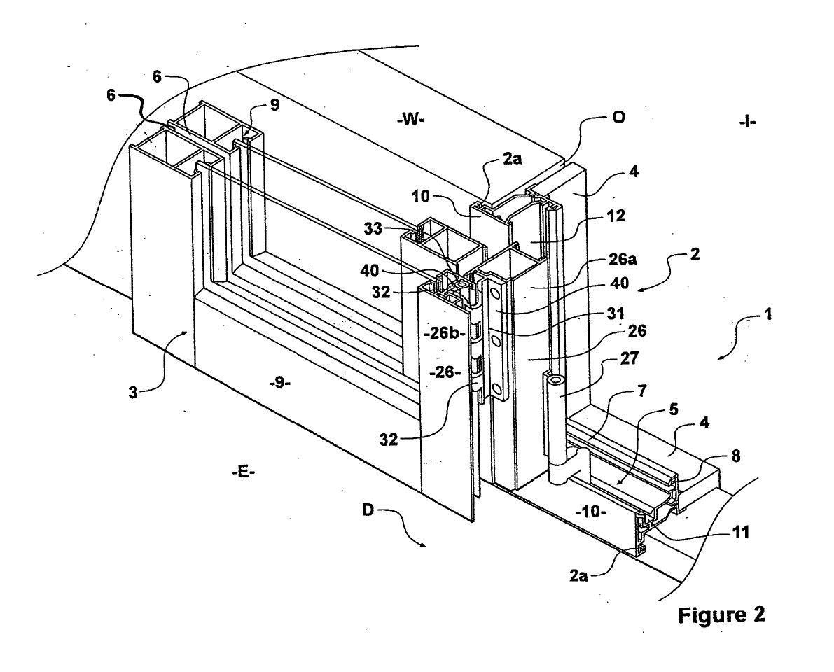

Referring now specifically to FIGS. 1 and 2 of the drawings.

The closure as generally indicated by arrow 1 preferably includes a frame 2 and closure assembly 3 which is mounted in an opening O of a wall W. In this instance the embodiment provides an opening from an interior I to an exterior E of a building, effectively to allow ingress and egress from the building from a deck D.

Preferably the frame 2 is provided as a perimeter frame engaged within the opening O and typically it has flanges overlying adjacent portions of the opening O to allow a sufficient seal to be formed between the interior and exterior when the closure is in a closed position. The flanges are accompanied by appropriate seals where required.

The frame 2 preferably incorporates a liner 4, preferably formed in timber on this occasion and which is engaged with adjacent remaining portions of the frame 2. The liner 4 is of dimensions so as to provide an appropriate “reveal”, internally of the closure 1 and to facilitate convenient mounting of architraves and the like (not shown).

Remaining portions of the frame 2 are preferably formed in extruded aluminium alloy and incorporate a frame rebate 5 within which panels of the closure assembly 3 can lie. In this preferred form of the invention, preferably the depth of the panels is substantially commensurate with a corresponding depth of the rebate 5, such that when the panels are arranged in a closed position (not shown) the panels substantially align with the plane of the opening with interior faces 6 of the panels abutting sealing means 7 engaged on an abutment base 8 of the rebate 5.

Preferably exterior faces 9 of the panels are substantially in alignment with a frame front face 10 when in a closed position for aesthetic and other constructional reasons.

Preferably the elements 11 forming the sill and head (not shown) of the frame 2 are arranged in a substantially corresponding configuration (although this is not essential to the invention), and further, preferably the opposing jambs 12 are each arranged to be substantially corresponding in configuration. It is however to be appreciated that an alternative forms of the invention, the elements forming the head jambs 12 and sill 11 can each be formed in a substantially corresponding configuration and cross section for economy.

Turning now specifically to FIG. 1, preferably the closure panels 3 are each provided as doors and typically include substantially upright, styles 13 joined by substantially horizontal rails 14. The construction and arrangement of the doors is preferably according to substantially known techniques, and are typically arranged to mount a glazing panel there within. (This is not essential).

In this form of the invention, a bi-fold arrangement is shown with a closure assembly 3 including a first panel 20 and a second panel 21.

The style 13 defining the first edge 22 of said first panel 20 is pivotally mounted, preferably by means of hinges (not shown), to adjacent appropriate portions of the frame 2 and thereby to jamb 12, such that the panel is engaged with portions of the opening. Accordingly, the first panel 20 can pivot from a closed position substantially aligned with the plane of the opening, to a position as shown, where it is substantially orthogonal to the plane of the opening, and beyond.

The style 13 defining the second edge of 23 of said first panel 20 is arranged with hinge mechanisms 24 spaced along its length, to engage substantially corresponding portions of the style 13 defining the first edge 25 of said second panel 21.

The second edge 26 of said second panel 21 is secured to be moveable substantially in the plane of the opening relative to the sill 11 (and preferably although not essentially the head) via a pivotally mounted lug 27 connected with adjacent portions of the second edge 26 of the second panel 21, to position an offset foot 28 to overlie portions of the rebate 5, and pivotally connect via a foot 29 with a moveable bogie (not shown), so as to slide within a track 30 positioned in at least the sill 11 of the frame 2 as the panels of the closure assembly 3 are moved from the closed position, to an open position, substantially as is shown by FIG. 1.

In the preferred form of the invention, the bogie incorporates suitable wheels, bearings and the like, and furthermore preferably the track 30 is provided with an additionally hard wearing insert, for example an insert constructed in alternative hard wearing or lubricative materials including stainless steel, certain plastics and the like.

Preferably the lug 27 is provided with a mechanism for positional adjustment of the engagement between the panel 21 and the frame 2 and thus, the geometry of the closure assembly 3 as a whole, although this is in no way essential to the invention.

It will be appreciated that commencing front a position where the panels 20 and 21 are arranged across the frame 2 opening in a closed position, substantially aligned with the plane of the opening, upon release of suitable catches and the like (not shown in this Figure), the second edge 23 of the first panel 20 and the first edge 25 of the second panel 21 are pushed outwardly of the frame 2 such that the panels 20 and 21 concertina together to an open position as is shown by FIG. 1, until such time as at least the first panel 20 extends outwardly substantially orthogonal to the opening. In the preferred form of the invention, the geometry of the panel sizes can be adjusted such that in this position stability to the panel assembly 3 can be achieved by having at least one panel of a size different than the other so as to effectively “triangulate” the assembly, however, this is not essential to the invention.

Referring now to FIGS. 1 and 2, it will be seen that the style 13 of the second side edge 26 of said second panel 21 is provided to be movably engaged with the opening via a style hinging mechanism 31. In this form of the invention, the second side edge 26 is constructed of a pair of pivotally connected portions, a primary portion 26a and a secondary portion 26b. The primary portion 26a is provided to facilitate mounting of the lug 27 and the secondary portion 26b is arranged to cooperate with remaining portions of the second panel 21, and to form remaining portions of that panel 21.

In the preferred form, the style hinging mechanism 31 is arranged on offset leaves 32, such that the knuckle 33 of the hinge is mounted to facilitate convenient pivoting of the primary and secondary portions 26a and 26b relative to one another as is shown by FIG. 2, yet when in an aligned position as shown by FIG. 1, said style hinging mechanisms 31 are hidden from view.

In the preferred form, portions of the primary and secondary portions 26a and 26b where they meet substantially overlap as is seen by FIG. 1, such that any joint gap has minimal visual impact unless the second side edge 26 of the panel 21 is pivoted or “broken” as is shown by FIG. 2.

The positioning of the knuckle 33, and thus preferably the dimensions of the primary and secondary side edge portions 26a and 26b are arranged such that the knuckle 33 is positioned to facilitate movement of the closure assembly 3 when concertinaed, so that the panels of the closure assembly 3 can be rotated to a position where they are oriented along side portions of the wall adjacent to the opening O in substantial alignment with the plane of the opening. Accordingly, the invention allows for the bi-folded panels to be rotated from the substantially orthogonal projecting position, toward a position whereby they substantially align with the opening, typically overlying portions of the exterior or interior wall adjacent the opening. The substantial portion of the weight of the closure assembly is supported by the frame, thereby avoiding the leverage effect (causing sagging, frame distortion etc) found in the prior art.

It will be appreciated that in this position, the knuckle 33 of the hinge, and the offset nature of the hinging mechanism 31 is arranged to enable the second panel 21 to substantially overlie the first panel 20 when in this position with the panels oriented alongside the opening and lying compactly and conveniently against the wall.

Securing means 40 are positioned on said primary and secondary portion 26a and 26b so as to preferably hold the second side edge 26 of the panel 21 in the “normal” aligned orientation as shown by FIG. 1.

In the preferred form the securing means 40 are provided in the form of magnets, such as “earth magnets” which are engaged with convenient opposing portions of the primary and secondary portions 26a and 26b, preferably adjacent the hinging mechanism 31, and thus internally of the second side edge 26 of the second panel 21 when it is in the “normal” configuration.

The securing means 40 are arranged of sufficient strength and in such a position so as to maintain the side edge 26 in the “normal” configuration, through predetermined normal use, however are arranged of such a strength so as to be releasable under a predetermined load, for example, a user exerting pressure on the outwardly projected second and first edges of the first and second panels 20 and 21, when said panels 20 and 21 are concertinaed adjacent the side of the opening O.

When a predetermined pressure is applied to the concertinaed assembly, the securing means 40 releases and enables the concertinaed closured assemblies to adopt the position as is shown by FIG. 2, this position being a “breaking” of the second side edge 26 of the second panel 21.

Whilst magnetic releasable securing means 40 is in this form of the invention preferred, it will be appreciated that in alternative forms of the invention alternative releasable securing means 40 can be provided including typically biased ball and corresponding detent and arrangements, spring catch assemblies, operated release arrangements and the like.

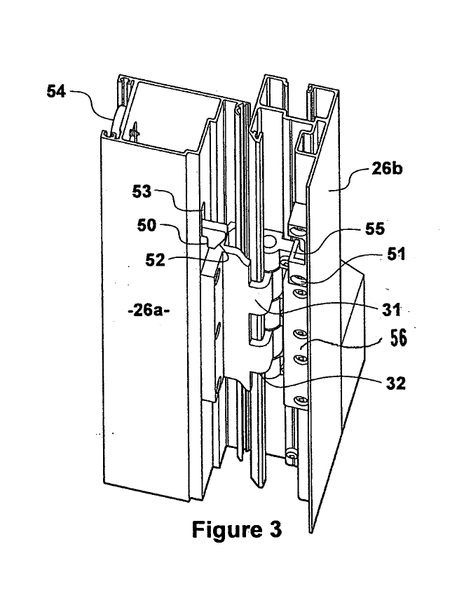

FIG. 3 shows the incorporation of a further, preferred, feature into the closure. In this embodiment a “latch”, has been included. The latch can be included either in addition to another securing means 40, such as a magnet as described above, or the latch can form the sole securing means.

In the preferred embodiment shown in FIG. 3 the latch includes a hook 50 and a catch 51. The hook 50 is attached to the primary portion 26a of the second side edge 26 of the panel 21 (not shown in this Figure) such that its base 54 (partially obscured from view) is attached to the face of the primary portion 26a that would abut the frame when the closure assembly is in a closed position. The face of the primary portion 26a to which the base 54 is attached has a hole in it (obscured from view) that allows the hook 50 to pass through this face. The face of the primary portion 26a to which the hinging mechanism 31 is attached also has a hole 53 through it, through which the hook 50 also passes. The hook 50 has a sloped outer edge 52 and the base 54 is connected to the primary portion 26a such that the hook 50 may pivot vertically.

The second side edge 26 is shown here in a “broken” position. As the second side edge 26 is brought towards a “normal” position (the position shown in FIG. 1) the hinging mechanism 31 will close and the hook 50 will be brought towards the catch 51, which is attached to the secondary portion 26b. As the hook 53 is pressed against the catch 51, its sloped outer edge 52 and the extension of the hole 53 above the hook 50 allow the hook 50 to lift. Once the hook 50 has been lifted to the height of the top of the outer edge 55 of the catch 51, the hook 50 will fall into the catch 51 due to gravity, locking the closure assembly in a “normal” position. The incorporation of this additional feature may be required where the closure assembly is exposed to significant pressure such as high winds.

In order to release the hook 50 from the catch 51, pressure is applied to the bottom portion (obscured from view) of the base 54. As the base 54 is attached in such a way that the hook is pivotable, this application of pressure causes the hook 50 to lift out of the catch 51. Rotating the secondary portion 26b while simultaneously applying pressure to the bottom portion of the base 54 allows the closure assembly to resume the broken position shown in FIG. 3 and FIG. 2.

The latch discussed above is an optional additional feature and is in no way essential to the invention. Further, as would be known to one skilled in the art, the latch shown in FIG. 3 is merely an example of the many variations of securing means that may be included in the present invention.

Whilst the invention has been described with reference to a bi-fold closure assembly incorporating a pair of panels arranged to be concertinaed one relative to the other, it is to be appreciated that in alternative arrangements, a plurality of pairs of panels can be provided and furthermore, a casement door assembly can be arranged to hang off the bi-fold pairs. In such arrangements, naturally closure panel sizes, including style sizes and the like, together with hinge and lug 27 geometry, will need to be adjusted so as to facilitate operation according to the principles described herein before.

Thus by this invention there is provided; a bi-fold closure assembly enabling a substantially fold-back arrangement of concertinaed doors relative to portions of the wall adjacent in the opening.

The foregoing describes the invention including a preferred form thereof. Alterations and modifications as would be readily apparent to a person skilled in this art are intended to be included within the scope of the invention disclosed.

What we claim is:

1. A closure for an opening including at least one pair of panels, wherein a first side of a first panel of the pair of panels is pivotally mounted adjacent a side of a frame to pivot from a position wherein the panel is substantially in alignment with the opening, through a position substantially orthogonal to the opening and beyond, the first side of a second panel is pivotally mounted adjacent a second side of the first panel, the second side of the first panel being substantially opposite the first side of the first panel, and a portion adjacent the second side of the second panel is engaged with portions of the opening, the panels being moveable from a closed position across the opening to a position where the panels are substantially concertinaed together, the second side of the second panel including a primary portion moveably engaged with the opening and a secondary portion pivotally connected to the primary portion, the secondary portion being capable of movement from substantial alignment with the primary portion to substantial alignment with remaining portions of the second panel as said concertinaed panels are moved toward alignment with the opening but remote from the opening.

2. A closure for an opening according to claim 1 wherein the primary and secondary portions are pivotally connected via hinges engaged therebetween.

3. A closure for an opening according to any one of the preceding claims wherein a releasable securing means is positioned adjacent to the primary and secondary portions to releasably retain the primary and secondary portions in alignment, and to facilitate release of said alignment when predetermined.

4. A closure for an opening according to claim 3 wherein the securing means is magnetic.

5. A closure for an opening according to any one of the preceding claims wherein the closure includes a releasable latch that automatically latches upon alignment of the primary and secondary portion.

6. A closure for an opening according to claim 5 wherein the latch includes a hook and a catch.

7. A closure for an opening according to any one of the preceding claims wherein the engagement between the second side of said second panel and said frame is arranged to align within the periphery of the frame.

8. A closure for an opening according to claim 7 wherein at least one portion of the engagement is positioned to support the panels relative to the frame.

9. A closure substantially as herein described with particular reference to any one of the Figures.
